(19) United States
(12) Patent Application Publication
(10) Pub. No.: US 2006/0172718 A1
(43) Pub. Date: Aug. 3, 2006

(54) Mixer stage and method for mixing signals of different frequencies

(75) Inventors: Andreas Leistner, Flein (DE); Herman Jalli Ng, Pfullingen (DE); Hans Sapotta, Heilbronn (DE)

Correspondence Address: BIRCH STEWART KOLASCH & BIRCH, PO BOX 747, FALLS CHURCH, VA, 22040-0747, US

(73) Assignee: ATMEL GERMANY GMBH, Heilbronn (DE)

(21) Appl. No.: 11/340,602

(22) Filed: Jan. 27, 2006

(30) Foreign Application Priority Data
Jan. 28, 2005 (DE) DE 102005005332.7

(51) Int. Cl. H04B 1/26

(52) U.S. Cl. 455/323

(57) ABSTRACT

A mixer stage is provided that mixes a differential input signal with a differential square-wave signal of an oscillator, having a first amplifier element and a second amplifier element, each of which amplifier elements has a first current connection, a second current connection, and a connection for the differential input signal, having four control elements and also a first output and a second output, wherein the four control elements are modulated in pairs by the differential square-wave signal, thereby connecting each second current connection alternately, and in each case individually, to one of the two outputs. The mixer stage has field-effect transistors as amplifier elements whose first current connections are connected to a constant reference voltage. In addition, a method for mixing frequencies that uses this mixer stage is also disclosed.

This nonprovisional application claims priority under 35 U.S.C. §119(a) on German Patent Application No. DE 102005005332.7, which was filed in Germany on Jan. 28, 2005, and which is herein incorporated by reference.

### BACKGROUND OF THE INVENTION

1. Field of the Invention

The present invention relates to a mixer stage that mixes a differential input signal with a differential square-wave signal of an oscillator, said mixer stage having a first amplifier element and a second amplifier element, each of which amplifier elements has a first current connection, a second current connection, and an input for the differential input signal, and having four control elements and also a first output and a second output, wherein the four control elements are modulated in pairs by the differential square-wave signal, thereby connecting each second current connection alternately, and in each case individually, to one of the two outputs.

The invention further relates to a method for mixing a first signal which has a first frequency, with a second signal which has a second frequency, including the steps of supplying the first signal in differential form to a first input and a second input of a mixer stage having a first amplifier element and a second amplifier element, each of which elements has a first current connection, a second current connection, and an input for the differential input signal, and having four control elements and a first output and a second output, wherein the four control elements are modulated in pairs by the differential square-wave signal, thereby connecting each second current connection alternately, and in each case individually, to one of the two outputs.

2. Description of the Background Art

In this context, it is self-evident that an ideal square-wave form can only be achieved in an approximate manner in technical implementations. The term “square-wave signal” thus refers to all technically possible approximations of a square-wave signal, and thus also encompasses signals with approximately square-wave form, such as are produced, for example, by a Fourier synthesis of a square-wave signal using an infinite series of signal components.

A mixer stage with these features and an additional current source connected to the first current connections of the two field-effect transistors is known as a Gilbert cell, and is explained, for example, in the publication, “Eine neue HF-Mischstufe,” by Prof. Dr. Hans A. Sapotta, F H Karlsruhe, MPC-Workshop February 2004. Moreover, a method with these features is also known from the same publication, wherein the possibility of using a square-wave signal is mentioned but is rejected for the Gilbert cell on account of disadvantageous effects (undesirable harmonic mixing).

The mixer stage is a circuit with central importance in today's wireless communications. Since the invention of the superhet principle in the USA in the late 1920s, mixer stages are to be found in nearly every receiver worldwide. The only exceptions are radio clocks with direct-detection receivers and simple remote control units in the USA that work with superregenerative receivers. Thus, it is possible to establish a lower bound on the number of mixer stages in use as the number of operable receivers worldwide. This is approximately five billion radios with at least one mixer stage (and actually three stages as a general rule), two billion television sets, and approximately another one billion cell phones. There are thus at least eight billion mixer stages in use worldwide. These numbers demonstrate the importance accorded to mixer stages in practice.

The fundamental task of a mixer stage resides in a multiplication of two signals in the high-frequency range, which takes place in an analog fashion. If one uses a cosine oscillation for each of two signals that are to be multiplied together, one obtains
Uout=k·U₁·U₂≈cos ω₁t·cos ω₂t=0.5·(cos(ω₁−ω₂)t+cos(ω₁+ω₂)t)

With the aid of a subsequent filter, it is possible to filter out one of the two frequencies (ω₁−ω₂) or (ω₁+ω₂), whose amplitude is proportional to one of the input voltages of the product U₁·U₂. The other input voltage can be normalized in this process. In principle, it is desired for mixer stages to produce a formally correct analog multiplication of two input voltages.

The aforementioned Gilbert cell already comes quite close to the formally correct analog multiplication. In the Gilbert cell, the two field-effect transistors together with the current source form a differential amplifier that amplifies an input signal Vin1 present at its inputs.

In this context the voltage requirement, in particular, of the differential amplifier is disadvantageous with regard to mobile applications. Using the set of four switching transistors as control elements, the output current of the differential amplifier is inverted as a function of a second input voltage. Here, the differential amplifier of the Gilbert cell in superhet structures is supplied with an amplified and bandwidth-limited antenna signal as its input signal, while the oscillator signal controls the four control transistors.

The advantages of the Gilbert cell over other prior art mixer structures are that the entire structure can be integrated in one technology (including MOS), that only low oscillator levels are needed, that the radiation of the oscillator toward the antenna can be controlled, and that the fundamental frequency of the oscillator signal is suppressed both toward the antenna and toward the intermediate-frequency (IF) amplifier, but is emitted as a common-mode signal at twice the oscillator frequency toward both the input and the output. As a result, the Gilbert cell permits high amplification, and thus suppresses the squelch tail of the intermediate frequency amplifier, and/or permits the use of IF filters with high insertion losses (SAW filters). It is also advantageous that the Gilbert cell is what is known as a four-quadrant mixer. This means that both input signals can take on either positive or negative values.

Because of these advantages, the Gilbert cell represents a standard for mixer circuits, and is also used as the benchmark when new technologies are introduced. Nonetheless, these advantages are also contrasted by disadvantages, which have to date been tolerated for lack of alternatives. Since the Gilbert cell is the basis of every single superhet receiver, the Gilbert cell is primarily required to meet the dynamic range requirements placed on the receiver. Dynamic range is interpreted here to mean both low noise and a high intercept point. Reception at the desired frequency is less important in this context than preventing reception at different, undesired frequencies. In modern-day receiver concepts, the mixer stage represents a signal processing bottleneck in terms of the desired dynamic range.

Since the antenna signal is fed to the control connections of the transistors of the differential amplifier, the differential amplifier constitutes the amplifying element of the Gilbert cell. Consequently, the known intermodulation behavior of the differential amplifier also plays a part in determining the large-signal stability. In this context, the linear region of the characteristic curve is generally limited to within a few mV of the value of the input signal of the differential amplifier. Inserting emitter resistors in the differential amplifier makes it possible to extend the linear region. However, this shifts the optimal generator resistance for minimal noise figures to values which generally cannot be implemented in high-frequency circuits.

In principle, it is possible to vary the amplification of the Gilbert cell by varying the second input voltage, which controls the four control transistors. Since the individual transistors each represent statistically uncorrelated noise sources, however, the output noise of the circuit for a second input voltage approaching zero does not approach zero to the same degree as the amplification does. Thus, the noise figure approaches infinity at the instants of the zero-crossing of the second input voltage.

In this regard, the aforementioned publication mentions the possibility of minimizing the duration of the zero crossing and maximizing the duration of the maximum amplification of the mixer stage by using a square-wave voltage as the control voltage for the four control transistors. However, this possibility is described in the same document as disadvantageous, since the harmonics of the square wave then also cause a mixing process which ultimately raises the noise figure of the Gilbert cell.

As a new mixer circuit, the aforementioned document proposes a circuit of three blocks connected in series. In a first block, two field-effect transistors with identical drain-source voltage are operated in their resistive region. In principle, for field-effect transistors which have a cutoff region, a resistive region, and a saturation region also known as the pentode region, a distinction is drawn among three regions, with the transistors of the field-effect transistors of a Gilbert cell being operated in the saturation region. In the resistive region, the field-effect transistor is operated with a voltage between gate and drain that is larger than the threshold voltage of the field-effect transistor. In this context, a dependence of the drain current on the gate-source voltage arises that is approximately linear at least in sections. In contrast, the pentode region is characterized by a voltage between the gate and drain which is smaller than the threshold voltage. An approximately quadratic function for the dependence of the drain current on the gate-source voltage then results.

During operation of the circuit proposed in said document in the resistive region, the result is a difference in the drain currents that is proportional to the product of the drain-source voltage (Vin1), which is the same for both field-effect transistors, and the difference between their gate-source voltages (Vin2). Transistors of a second stage wired as voltage followers conduct the drain currents of the field-effect transistors into a third stage that serves to take the difference of the currents and that can, for example, have a current mirror. Such a circuit is characterized by an improved dynamic range and reduced current consumption, but is only suitable as a two-quadrant mixer.

In the event that a four-quadrant mixer is desired which has a dynamic range that is improved over the dynamic range of a Gilbert cell, the aforesaid document proposes a variation on this circuit with field-effect transistors operated in the resistive region, in which a third field-effect transistor and a fourth field-effect transistor are likewise operated in the resistive region and are each connected to their own voltage follower of the second stage. A disadvantage here is the increased space required for the circuit due to the two additional field-effect transistors.

### SUMMARY OF THE INVENTION

It is therefore an object of the present invention to provide a circuit which, like a Gilbert cell, can be used as a four-quadrant mixer, has an increased dynamic range at an increased voltage, and does not have an increased space requirement.

This object is attained in a mixer stage of the aforementioned type in that the mixer stage has field-effect transistors as amplifier elements whose first current connections are connected to a constant reference voltage.

This object is further attained in a method of the aforementioned type in that field-effect transistors which have their first current connections connected to a constant reference voltage and which are modulated by the differential input signal in their resistive region are used as amplifier elements.

This circuit differs structurally from the Gilbert cell in that the current source of the differential amplifier is eliminated. In the mixer stage proposed here, the control transistors of the Gilbert cell are used simultaneously as switches for the mixer and as cascode transistors for the field-effect transistors. As a result of these measures, the required supply voltage is reduced. As compared to the other alternative mentioned in the cited publication, with four transistors operated in the resistive region, chip space is saved by the elimination of the third and fourth field-effect transistors.

Due to the use of a local oscillator, which supplies a square-wave signal and modulates control elements with a square-wave signal, a constant drain voltage is present at the field-effect transistors that reduces the radiation of the local oscillator at the mixer input and improves the noise characteristics. A particular advantage of the new circuit is that the field-effect transistors can be operated in the resistive region, because this results in a formally correct multiplication of the oscillator frequency and of the frequency of the input signal. By contrast, the transistors of the differential amplifier of the Gilbert cell are operated in the pentode region.

With respect to embodiments of the mixer stage, it is preferred that the first current connection of the first amplifier element is connected through a first control element to the first output and through a second control element to the second output, that the first current connection of the second amplifier element is connected through a third control element to the first output and through a fourth control element to the second output, and that the differential square-wave signal differentially modulates the first control element together with the fourth control element and differentially modulates the second control element together with the third control element.

This concrete circuit design embodiment permits modulation of the four control elements by the differential square-wave signal such that each current connection is connected in alternation and individually to one of the two outputs.

The first field-effect transistor and the second field-effect transistor can each be implemented in the form of an NMOS transistor, and for the four control elements to be implemented as bipolar NPN transistors.

The first field-effect transistor and the second field-effect transistor can each be implemented in the form of an NMOS transistor, and for the four control elements to be implemented as NMOS transistors.

Alternatively, the first field-effect transistor and the second field-effect transistor can each be implemented in the form of a PMOS transistor, and for the four control elements to be implemented as bipolar PNP transistors.

Another alternative provides for the first field-effect transistor and the second field-effect transistor to each be implemented in the form of a PMOS transistor, and for the four control elements to be implemented as PMOS transistors.

These embodiments demonstrate the wide range of implementation of the device aspects of the invention in the form of integrated circuits. The embodiment with enhancement type NMOS field-effect transistors with bipolar NPN transistors is especially preferred in this regard, since these field-effect transistors have the best transistor characteristics and bipolar transistors have no interfering body effect.

It is further preferred for the first field-effect transistor and the second field-effect transistor to both have equal transconductance values and equal threshold voltage values.

In conjunction with modulation of the control elements with the square-wave signal, this embodiment results in an identical, and in the ideal case constant, drain-source voltage of the field-effect transistors, which ultimately permits a formally correct mixing by multiplication of the oscillator signal with the input signal.

With respect to embodiments of the method, an amplification of the mixer stage is controlled by an operating point voltage at control connections of the field-effect transistors and/or at control connections of the control elements.

As a result, the mixer stage is suitable for use as a continuously adjustable amplifier element in an automatic gain control (AGC) loop, for example.

Moreover, the mixer stage can be used in a mobile application, because in this application the reduced voltage requirement resulting from the elimination of the current source of the Gilbert cell has an especially advantageous effect in a reduction in the power consumption.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, are not limitive of the present invention, and wherein the FIGURE shows, in schematic form, a first embodiment of a mixer stage with NMOS transistors as field-effect transistors and bipolar transistors as control elements.

### DETAILED DESCRIPTION

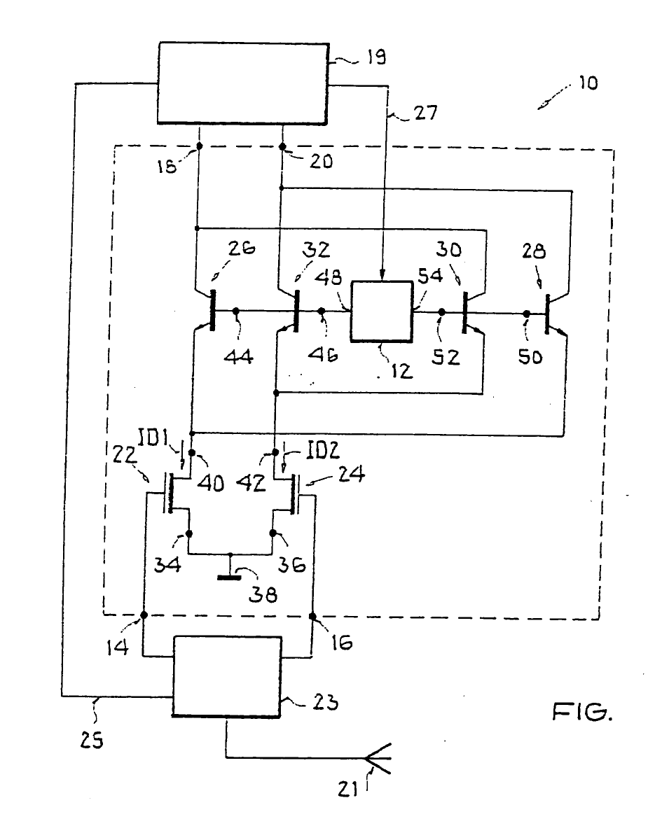

FIG. 1 shows a mixer stage 10 with an oscillator 12, a first input 14, a second input 16, a first output 18, a second output 20, a first field-effect transistor 22, a second field-effect transistor 24, and four control elements 26, 28, 30 and 32. The field-effect transistors serve here as the aforementioned amplifier elements. A first current connection 34 of the first field-effect transistor 22 is connected to a first current connection 36 of the second field-effect transistor and a reference voltage 38. A second current connection 40 of the first field-effect transistor 22 is connected through a first control element 26 to the first output 18 and through a second control element 28 to the second output 20. A second current connection 42 of the second field-effect transistor 24 is connected through a third control element 30 to the first output 18, and through a fourth control element 32 to the second output 20. The two outputs 18 and 20 lead, for example, to an output circuit 19 in which currents flowing through the outputs 18, 20 are converted into voltages and signals are demodulated.

A control connection 44 of the first control element 26 is connected to a control connection 46 of the fourth control element 32 and a first oscillator output 48. Similarly, a control connection 50 of the second control element 28 is connected to a control connection 52 of the third control element 30 and a second oscillator output 54. The oscillator 12 provides the square-wave signal in differential form between its oscillator outputs 48, 54 so that a signal level at the oscillator output 48 is high (low) when a signal level at the oscillator output 54 is low (high). The square-wave signal can swing digitally by ±0.5 V about a common-mode modulation value of 1 volt, for example. For example, the signal between the inputs 14 and 16 can be an analog signal from a receiving antenna 21 that has been processed and/or amplified by an input circuit 23. One may use a sine or cosine signal between the inputs 14 and 16 as a starting point for achieving an understanding of the mixer stage 10.

The field-effect transistors 22 and 24 can be implemented equally well as junction FETs or MOSFETs. In the embodiment shown, the field-effect transistors 22 and 24 are implemented as n-channel MOSFETs, and the four control elements 26, 28, 30, 32 are implemented as bipolar NPN transistors. Accordingly, the first current connections 34 and 36 are source connections, and the second current connections 40 and 42 are drain connections.

As is known, such field-effect transistors 22, 24 have three operating regions: the cutoff region, the resistive region, and the saturation region. In the resistive region, the field-effect transistor follows the relationship
ID=B0(VGS−VTH−VDS/2)VDS.

Here, B0 designates what is known as the transconductance factor, which is influenced by the gate oxide thickness and the charge-carrier mobility. VTH is the threshold voltage of the transistor. In the circuit shown, a drain current ID1 flows in the second current connection 40 of the first field-effect transistor 22, and a drain current ID2 flows in the second current connection 42 of the second field-effect transistor 24.

As part of a preferred embodiment, the two field-effect transistors 22, 24 both have equal transconductance factors B01, B02 and equal threshold voltages VTH1 and VTH2. When the control elements 26, 28, 30 and 32 are digitally switched between the “conducting” and “nonconducting” states by the square-wave signal, an identical constant drain-source voltage VDS results for both field-effect transistors between their connections 40 and 34, or 42 and 36.

Due to the identical drain-source voltage VDS, the drain currents can be expressed as:
ID1=B0(VGS1−VTH−VDS/2)VDS and
ID2=B0(VGS2−VTH−VDS/2)VDS.

If one takes the difference of the two drain currents ID1, ID2, one obtains the linear relationship between drain current difference and gate voltage difference:
ID1−ID2=B0 VDS(VGS1−VGS2).

Each of these drain currents ID1 and ID2 is switched alternately to the first input 18 and the second input 20 by the four control transistors 26, 28, 30, 32, which corresponds to a multiplication of each drain current ID1, ID2 with a periodically alternating arithmetic sign on account of the fact that the four control transistors 16, 28, 30, 31 serving as control elements are driven by a differential square-wave signal. The resulting product of the output currents, which is to say the currents into/out of the outputs 18, 20, then contains terms with the frequencies (ω₁−ω₂), (ω₁+ω₂), where the indices 1 and 2 in this order are associated with the input signal and the oscillator signal. The sum term and the difference term each result from the multiplication of the input signal, which is present in differential form between the inputs 14 and 16, by the first Fourier component of the square-wave signal, which is to say a trigonometric function whose argument contains the oscillator frequency.

Once again, a subsequent filter in the output circuit 19 can filter out one of the two frequencies (ω₁−ω₂) or (ω₁+ω₂), whose amplitude is proportional to one of the input voltages of the product U₁·U₂. The other input voltage can be normalized in this process.

Additional higher order terms, as are produced by multiplication with additional Fourier components at three, five, seven, etc. times the oscillator frequency, are likewise suppressed by the filtering.

As already mentioned, FIG. 1 explicitly shows a mixer stage 10 in which the field-effect transistors 22 and 24 are each implemented as NMOS transistors, and the four control elements 26, 28, 30, 32 are implemented as bipolar NPN transistors. It is a matter of course, however, that the first field-effect transistor 22 and the second field-effect transistor 24 could each be implemented as NMOS transistors, and the four control elements 26, 28, 30, 32 could be implemented as NMOS transistors, or that the first field-effect transistor 22 and the second field-effect transistor 24 could each be implemented as PMOS transistors, and the four control elements 26, 28, 30, 32 could be implemented as bipolar PNP transistors, or that the first field-effect transistor 22 and the second field-effect transistor 24 could each be implemented as PMOS transistors, and the four control elements 26, 28, 30, 32 could be implemented as PMOS transistors.

Output circuit 19 and input circuit 23 can be connected together by a connection 25, for example in order to implement a control loop for controlling the amplification of the field-effect transistors through control of the common-mode value of their modulation. Similarly, the output circuit 19 can also be connected to the oscillator 12 through a connection 27 in order to tune the oscillator's frequency such that a desired receiving frequency is shifted to a predetermined intermediate frequency and/or to set a common-mode value of the differential oscillator signal for the purpose of setting the operating point of the control elements 26, 28, 30, 32.

The voltages at the base of the bipolar transistors serving as control elements 26, 28, 30, 32 result from a superposition of a DC operating point voltage V_{DC2} and a differential AC voltage Vᵢₙ₂: V_{DC2}±½×Vᵢₙ₂. The voltages at the inputs 14 and 16, which is to say at the gate connections of the field-effect transistors 22 and 24, result from a superposition of a DC operating point voltage V_{DC1} and a differential AC voltage Vᵢₙ₁: V_{DC1}=½Vᵢₙ₁. The amplification of the mixer stage 10 can be continuously adjusted by means of the operating point voltages V_{DC2} at the base of the control elements 26, 28, 30, 32 and V_{DC1} at the gate of the field-effect transistors 22 and 24. In particular, the source-drain operating point voltage of the field-effect transistors 22 and 24, which is set through the voltage V_{DC2} at the base of the control elements 26, 28, 30, 32, has a direct influence on the transconductance of the MOS amplifier stage formed of field-effect transistors 22, 24 of this mixer stage 10. In this way, it is possible to employ the mixer stage 10 as a continuously adjustable amplifier element in the AGC loop.

For an implementation of the AGC loop, the output circuit 19 has a level detector, a comparator, a target level transmitter, an integrator, and a control element that controls the operating point voltage of the field-effect transistors 22, 24 through the connection 25 to the input circuit 23 and also controls the operating point voltage of the control elements 26, 28, 30, 32 through the connection 27 to the oscillator 12. The signal level of the output signal of the mixer stage 10 present between the outputs 18 and 20, detected by the level detector, is compared by the comparator with a target value from the target level transmitter, which can be accomplished by taking a difference, for example. The difference is then integrated and controls the aforementioned operating point voltages by means of the control loop closed by the control element.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A mixer stage for mixing a differential input signal with a differential square-wave signal of an oscillator, the mixer stage comprising:
a first amplifier element and a second amplifier element, the first amplifier element and the second amplifier element each having a first current connection, a second current connection, and a connection for the differential input signal;
four control elements; and
a first output and a second output,
wherein the four control elements are modulated in pairs by the differential square-wave signal, thereby connecting each second current connection alternately, and in each case individually, to one of the two outputs, and
wherein the first amplifier element and the second amplifier element are field-effect transistors whose first current connections are connected to a constant reference voltage.

2. The mixer stage according to claim 1, wherein the second current connection of the first amplifier element is connected through a first control element to the first output and through a second control element to the second output, wherein the second current connection of the second amplifier element is connected through a third control element to the first output and through a fourth control element to the second output, and wherein the differential square-wave signal differentially modulates the first control element together with the fourth control element and differentially modulates the second control element together with the third control element.

3. The mixer stage according to claim 1, wherein the first amplifier element and the second amplifier element are each NMOS transistors, and the four control elements are bipolar NPN transistors.

4. The mixer stage according to claim 1, wherein the first amplifier element and the second amplifier element are each an NMOS transistor, and the four control elements are NMOS transistors.

5. The mixer stage according to claim 1, wherein the first amplifier element and the second amplifier element are each a PMOS transistor, and the four control elements are bipolar PNP transistors.

6. The mixer stage according to claim 1, wherein the first amplifier element and the second amplifier element are each a PMOS transistor, and the four control elements are PMOS transistors.

7. The mixer stage according to claim 1, wherein the first amplifier element and the second amplifier element both have equal transconductance values and equal threshold voltage values.

8. A method for mixing a first signal which has a first frequency, with a second signal which has a second frequency, the method comprising the steps of:
providing a mixer stage having a first amplifier element and a second amplifier element, each of which has a first current connection, a second current connection, and a connection for the differential input signal, four control elements and a first output and a second output, the four control elements being modulated in pairs by the differential square-wave signal to connect each second current connection alternately, and in each case individually, to one of the two outputs; and
supplying the first signal in differential form to a first input and a second input of the mixer stage,
wherein the first amplifier element and the second amplifier element are field-effect transistors that have their first current connections connected to a constant reference voltage and are modulated by the differential input signal in their resistive region.

9. The method according to claim 8, wherein amplification of the mixer stage is controlled by an operating point voltage at control connections of the first amplifier element and the second amplifier element and/or at control connections of the control elements.

10. The mixer stage according to claim 1, wherein the mixer stage is provided in a mobile apparatus.
